(19) United States
(12) Patent Application Publication
(10) Pub. No.: US 2024/0253201 A1
(43) Pub. Date: Aug. 1, 2024

(54) METHOD FOR OPERATING A POWER TOOL, AND POWER TOOL

(71) Applicant: Hilti Aktiengesellschaft, Schaan (LI)

(72) Inventors: Thomas MAHLER, Laage (DE); Michael LACHER, Schwabmuenchen (DE)

(21) Appl. No.: 18/285,429

(22) PCT Filed: Apr. 7, 2022
(86) PCT No.: PCT/EP2022/059184

§ 371 Date: Oct. 3, 2023

(30) Foreign Application Priority Data
Apr. 22, 2021 (EP) 21169898.0

(51) Int. Cl. B25F 5/00

(52) U.S. Cl. CPC B25F 5/00

(57) ABSTRACT

A method for operating a power tool, wherein an application-optimized device characteristic is selected and/or configured by a user of the power tool, wherein the application-optimized device characteristic is defined within the qualified operating range for the power tool. The device characteristic is characterized by a spread value S, wherein the spread value S lies in a range from 0.2 to 0.6. By selecting or configuring the device characteristic, it is possible for the performance of the power tool to be considerably improved since, by determining the device characteristic, the power tool can be made to operate in a range of torque and speed that is optimized, for example, for a certain tool or for a certain application. In a second aspect, the invention relates to a power tool for carrying out the operating method.

The present invention relates to a method for operating a power tool, wherein an application-optimized device characteristic is selected and/or configured by a user of the power tool, wherein the application-optimized device characteristic is defined within the qualified operating range for the power tool. In a second aspect, the invention relates to a power tool for carrying out the operating method.

### BACKGROUND

The prior art discloses power tools by means of which work—for example on a building site or in the DIY sector—can be carried out. Power tools may be cutting devices or cut-off devices, angle grinders or cut-off grinders, core drilling devices, hammer drills or chisel drills, without being restricted thereto. The power tools usually comprise tools, which may be disk-shaped, rotating tools, such as cut-off disks or grinding disks, or hammering or chiselling tools.

### SUMMARY OF THE INVENTION

The tools of the power tools that are known from the prior art are usually driven via an electric motor within the power tool. The motor rotates, with the rotation of the motor being converted into a rotation of the tool or into a hammering or chiselling movement of the tool. In addition, power tools may be equipped with a gearbox such that the power tool can be operated in different gears. Many of the power tools may be operated with different tools. For example, different grinding disks may be fastened to a grinding device in order to carry out different tasks or meet different requirements. The tools may differ, for example, in terms of fineness, size, diameter or many other properties. It has previously been the case in the prior art that the power tools are usually operated with a standard set of parameters of speed and torque. This means that the power tool is always driven in the same way irrespective of whether a large or small, heavy or light tool, or a tool differing in some other way, is arranged on the power tool. For individual tools or applications, this situation can lead to the work to be carried out not being implemented in an optimal manner because the operating parameters, such as speed or torque, are not optimally tailored to the tool used or to the corresponding application. This applies all the more in the case of power tools with gearbox which, in addition to the different tools and applications, can also be operated in different gears.

An object on which the present invention is based is that of overcoming the above-described disadvantages of the prior art and of specifying a method for operating a power tool in which operating parameters, such as speed and torque, can be better adapted to different tools or applications. It is also intended to provide a power tool by means of which the method can be implemented. A particular aim of the invention is that of providing improved adaptation of the operating behavior of the power tool for the application in which, for example, it is intended for a plastic-coated surface, such as, for example, an epoxy resin surface, to be ground. Owing to the particular properties of such surfaces, the machining of such plastic-coated surfaces represents a particular challenge in the design of a power tool.

According to the invention, a method for operating a power tool is provided. In the method, an application-optimized device characteristic is selected and/or configured by a user of the power tool, wherein the application-optimized device characteristic lies in a qualified operating range of the power tool. The device characteristic is characterized by a spread value S, wherein the spread value S lies in a range from 0.2 to 0.6.

In a preferred embodiment of the invention, the operating method is characterized by the following method steps:
a) configuring an application-optimized device characteristic for a power tool,
b) operating the power tool with the application-optimized device characteristic,
wherein the application-optimized device characteristic lies in a qualified operating range of the power tool.

It is preferred in the context of the invention that the device characteristic represents a relationship between the speed n and the torque M. The device characteristic can be represented in a speed-torque plot, wherein the torque M is plotted on the x-axis and the speed n is plotted on the y-axis of the corresponding plot. It is preferred in the context of the invention that the speed n represents the speed of the motor and/or the speed of the tool of the power tool.

The speed can be indicated, for example, in the unit rounds or rotations per minute (rpm). The speed preferably corresponds to the rotational speed of the motor or of the motor shaft of the power tool. In the context of the invention, the torque M is preferably indicated in the unit newton meter (Nm).

It is preferred in the context of the invention that the application-optimized device characteristic is configured on the basis of known standard characteristics. Preferably, a device characteristic can be determined by characteristic points which can be changed in the configuration by the user. In particular, the position and the coordinates of the characteristic points in a speed-torque plot can be changed by the user, which, in the context of the invention, is referred to as “configuration of a user-optimized or application-optimized device characteristic”. Preferably, the user-optimized or application-optimized device characteristic represents a device characteristic which has been optimized by the user for a certain application and/or for a certain tool of the power tool, wherein the optimization occurs in particular by the configuration of the user-optimized or application-optimized device characteristic. This configuration can in particular comprise the (re)positioning of characteristic points which determine a device characteristic.

The application-optimized device characteristic lies in a qualified operating range of the power tool. This is preferably that region in the speed-torque plot in which the power tool can be operated without an overload having to be expected or without there being an approval violation. It is preferred in the context of the invention that this qualified operating range is predetermined by the device manufacturer and stored in the device.

The selection or configuration of the device characteristic by the user advantageously makes it possible to achieve improved operation of the power tool and also improved device performance The operating parameters speed and torque which determine the operation of the power tool can be set individually by the user and in a tailored manner to a specific tool or a specific application by a corresponding device characteristic being selected. Through the selection of a device characteristic that is optimal for the planned application, it is possible for the power tool to operate in an operating range that is optimized for this application, this being reflected in particular in the relationship between speed and torque. In particular, the operation of the power tool according to a user-optimized device characteristic allows improved device performance along with improved adaptation of the operating parameters speed and torque to a specific application to be carried out.

The operation of the power tool occurs by the selection or configuration of the device characteristic by the user in particular in a “qualified operating range”. The term “qualified operating range” is preferably understood in the context of the invention as meaning that region in a speed-torque plot in which the device characteristics to be selected can be situated and in which there is no risk of a device defect or an operating risk, for example as a result of an excessive grinding disk speed. The qualified operating range can comprise, for example, idle running, operation under load, for example with increasing contact pressure, operation in a region of the loading maximum, and operation with the power tool under decreasing load or decreasing contact pressure. In other words, the tools can be operated in these operating ranges, with these operating ranges preferably falling in the qualified operating range. The qualified operating range preferably represents, for each characteristic, a “permitted” region in the speed-torque plot in which it is possible to operate with the power tool without having to expect impairments or risks. The user can advantageously operate with the power tool in the qualified range in a particularly safe and efficient manner.

It is preferred in the context of the invention that the selection or configuration of a device characteristic occurs by the user on the power tool itself. For this purpose, the power tool can have a user interface which, for example, takes the form of an input screen or touchscreen. By means of the user interface it is possible, for example, for there to be displayed various possible device characteristics available for selection for the operation of the power tool. The user can select a device characteristic that appears to be suitable for him. When making his decision, he can, for example, be guided as to what kind of a tool is arranged on the power tool or what kind of an application should be carried out with the power tool. The device characteristics available for selection can, for example, be displayed in a list or they can be displayed as different characteristics in a speed-torque plot. For example, the different characteristics can be marked by different colors such that the user can more easily distinguish the device characteristics from one another. The user of the power tool can carry out the selection of the device characteristic for example by means of keys, buttons or switches or directly by touching a touch-sensitive input screen. The power tool can, for example, comprise keys, buttons and/or switches as input means in order to allow a selection of the device characteristics for the user. For example, different characteristics can be displayed on a screen by repeated actuation of a switch or of a button, with it being possible for the selection of a certain characteristic to be confirmed, for example, by a long press on the switch or button.

In the context of the invention, the term “selection of a device characteristic” can also mean that a set of device characteristics is selected. This preferred embodiment of the invention is particularly preferred if the power tool can be operated in different gears. The set of device characteristics can, for example, allow optimized operation of the power tool in these different gears. It is preferred in the context of the invention that a device characteristic can be stored for each gear of the power tool. The different gears of the power tool can be realized, for example, by a mechanical gearbox or electronically.

Preferably, the device characteristics for the first, second, third and each further gear can form a set of device characteristics. It is preferred in the context of the invention that at least one device characteristic can be selected by a user of the power tool. It can be particularly preferred that more than one device characteristic or a set of device characteristics is selected.

Preferably, the selection or configuration of a device characteristic can be carried out on a preferably separate input device. This can be, for example, a mobile communication device, such as a smartphone or a tablet PC. For example, inputs or a selection can be carried out via an input screen of a mobile communication device. For this purpose, a software application (“app”) can be operated on the mobile communication device, this application providing, for example, an input screen for carrying out inputs or for carrying out a selection of device characteristics. The user can display the various device characteristics available for selection on the input device and select a desired device characteristic by touching the screen or actuating a switch, a button or a key. The device characteristic selected by the user can then be transmitted from the input device to the power tool such that the power tool can configure its operation on the basis of the selected device characteristic. When operating with the power tool, the user preferably moves dynamically on the device characteristic, with the current operating point being indicated by a value pair n/M of speed and torque on the device characteristic. It is preferred in the context of the invention that a device characteristic comprises a set of value pairs n/M of speed and torque. In other words, the device characteristic is formed by a set of speed/torque value pairs, with it being possible for each operating point of the power tool to be assigned a specific speed value n and a specific torque value M.

It may be preferred in the context of the invention that the preferably separate input device has detection means. This may be, for example, a scanning device, such as a barcode scanner and/or QR code scanner. In this way, a barcode or a QR code, which preferably comprises information on a device characteristic that is optimal for the operation of the power tool, can be scanned in by the detection means of the input device. The information can, for example, be evaluated in the input device or transmitted to the power tool. For this purpose, the input device can preferably comprise a communication interface by means of which data can be transmitted at least from the input device to the power tool. The data transmission can preferably occur wirelessly and be based, for example, on Bluetooth, WLAN, near-field communication or other suitable wireless communication technologies. The power tool preferably has a control device which preferably comprises a processor and/or a memory. The control device of the power tool is preferably designed to evaluate data obtained by the input device and thereby derive or determine information for the operation of the power tool. For example, the barcode or the QR code can comprise information on a tool that is used by the power tool such that the power tool can optimally set its operation according to the obtained information on the tool of the power tool by selecting an optimal device characteristic for the operation of the power tool with the tool. The barcode and/or the QR code can be, for example, arranged on the packaging of the tool or on the tool itself.

In this preferred embodiment of the invention, first of all a barcode or QR code is scanned in, with it being possible for the code to be scanned in particularly by the detection means of the input device. The code preferably comprises information on how optimal operation of the power tool can be made possible. It comprises in particular information on a device characteristic which allows optimum operation of the power tool with a certain tool or in a certain application.

It is preferred in the context of the invention that, in an exemplary embodiment of the invention of the method, first of all a barcode or QR code is scanned in, with it being possible for the scanned-in code to comprise, for example, information on the tool to be used. The scanning in preferably occurs by means of a detection means of an input device. The scanned-in information is then transmitted to the power tool, where it is evaluated in such a way that an optimum device characteristic is set for the power tool. This advantageously makes it possible to achieve optimized operation of the power tool in that better adaptation of the operating parameters speed and torque to the task to be performed and/or to the tool that is used can be carried out. In this preferred embodiment of the invention, the input device comprises a scanning device as detection means with which a barcode and/or QR code can be read. The information can then be transmitted from the input device to the power tool. For this purpose, there is preferably a preferably wireless communication connection between the power tool and the input device. The input device can be, for example, a mobile communication device, such as a mobile telephone or a smartphone. The first of all scanned-in and then transmitted data preferably comprise information on an optimal device characteristic for the operation of the power tool. The power tool can thus set this optimal device characteristic on the basis of the information obtained and operate in a qualified operating range.

The term “qualified operating range” will preferably be understood in the context of the invention as meaning that region in a speed-torque plot in which permitted device characteristics can be situated and in which there is no risk of a device defect or an operating risk. The individual subranges of the qualified operating range are defined or separated from one another by so-called inflection points in the device characteristic. In the context of the invention, these deflection points are referred to as characteristic points of the device characteristic. It is preferred in the context of the invention that a characteristic point is formed by a torque value M and a speed value n.

It is preferred in the context of the invention that a device characteristic comprises a number i of characteristic points and a number (i−1) of subranges. For example, a device characteristic can comprise five characteristic points and four subranges (see FIG. 1). In the example of the invention that is illustrated in FIG. 1, the device characteristic is determined or defined by five points, with the five inflection points subdividing the device characteristic into four subportions. The portions or characteristic points are preferably determined in dependence on the speed n, the torque M and a set control type of the power tool. Here, the term “control mode” or “control type” preferably indicates whether a torque-based control or a speed-based control is present. The subranges of the device characteristic are designated by Roman numerals in FIG. 1.

It is preferred in the context of the invention that the device characteristic is determined by characteristic points, with the characteristic points dividing the device characteristic into subportions. A basic idea of the present invention is that the user of the power tool can configure or change device characteristics by changing or redetermining the position or the coordinates of the characteristic points of a desired device characteristic. It is preferred in the context of the invention that the subportions of the device characteristic describe different phases during the operation with the power tool. Thus, for example, a first subportion can describe the idle phase in which the power tool is already switched on and the tool is moved, but work is not yet being carried out with the power tool. In this first or idle subrange of the device characteristic, the speed n can remain substantially constant, for example, for different torques M. This substantially constant subrange of the device characteristic is represented in the speed-torque plot in particular as a straight line with the gradient “zero”. It is preferred in the context of the invention that the highest speed value n_max is reached in this first subrange of the device characteristic. In other words, in the first subrange of the device characteristic, the power tool is preferably operated at the highest rotational speed n_max of the motor of the power tool. In the context of the invention, the speed n_max is preferably referred to as idle speed.

It is preferred in the context of the invention that the first subrange of the device characteristic is delimited by a first and a second characteristic point. The first characteristic point can be designated, for example, as point A and preferably represents the starting point of the first subrange of the device characteristic. The first characteristic point preferably represents the switching on of the power tool, with the power tool, by being switched on, starting with a movement of the tool of the power tool. The second characteristic point preferably represents the end point of the first subrange of the device characteristic; it can be designated, for example, as point B. It is preferred in the context of the invention that, at the second characteristic point of the device characteristic, the power tool starts working under load. The second characteristic point B thus preferably represents the starting point of the power tool. The first and the second characteristic point of the device characteristic preferably have substantially the same speed value, namely with preferably n_max, during the torque M_A of the first characteristic point, being considerably less than the torque M_B of the second characteristic point: M_A<M_B. The first and the second characteristic point of the device characteristic therefore lie on the straight line of gradient “zero”, with this straight line preferably lying at the level of the speed value n_max in the speed-torque plot.

A second subportion can represent, for example, working under load, with the power tool being operated in the second subportion of the device characteristic. Here, the torque M increases further in relation to M_B, whereas the motor speed n or the rotation speed of the motor decreases. The second subportion of the device characteristic is preferably delimited by the second characteristic point B as starting point and the third characteristic operating point D as end point. The third characteristic point preferably represents the loading maximum of the power tool. This preferably means in the context of the invention that, at the third characteristic point of the device characteristic, the torque is maximum, that is to say that the value M_max is reached. The rotational speed n_D preferably lies at a lower level than n_max.

If the work is continued with a decreasing load or a decreasing contact pressure starting from the third characteristic point, this is preferably referred to in the context of the invention as the third subrange of the device characteristic. The latter is delimited, as starting point, by the third characteristic point D and, as end point, by the fourth characteristic point E. The third and the fourth characteristic point of the device characteristic preferably have the same speed value, namely with preferably n_D, during the torque M_E of the fourth characteristic point, being considerably less than the torque M_D=M_max of the third characteristic point: M_E<M_D. The third and the fourth characteristic point of the device characteristic therefore lie on a further straight line of the speed-torque plot, which has a gradient “zero”, with this straight line lying at a constant speed, namely here preferably n_D. In the context of the invention, the speed n_D is preferably referred to as transition speed.

The fourth subrange of the device characteristic is delimited, as starting point, by the fourth characteristic point E and, as end point, by the fifth characteristic point F. The power tool is braked and possibly also blocked in this fourth subrange of the device characteristic. As a result, both the torque M and the speed n decrease: M_F<M_E and n_F<n_E. It is preferred in the context of the invention that the speed n at the fifth characteristic point assumes the value “zero”, that is to say that the tool of the power tool no longer rotates. The torque M of the fifth characteristic point can correspond to the torque M_A of the first characteristic point.

In a further preferred embodiment of the invention, the device characteristic can be selected or configured in that a number of characteristic points are determined by the user himself. This is preferably referred to in the context of the invention as “configuring the device characteristic”. The selection of a device characteristic can therefore comprise the configuration thereof. In other words, the selection of the characteristic in this embodiment of the invention particularly consists in that the characteristic points that constitute a device characteristic can be determined by the user of the power tool. In still other words, in this preferred embodiment of the operating method, the selection of the device characteristic occurs by virtue of the fact that the device characteristic can be configured by the user, or set by the user himself, by determining its characteristic points.

In a preferred exemplary embodiment of this configuration of the invention, a device characteristic is configured by the user himself in that the user determines characteristic points in a speed-torque plot that then form the device characteristic. In particular here, a qualified operating range of the power tool is used in whose limits the user can configure the characteristic himself. In other words, the qualified operating range comprises the permitted value pairs of speed n and torque M which the user may select for determining the characteristic points to define the device characteristic. This selection or determination of the characteristic points can occur in particular on an input device, such as a mobile communication device. The input data are then transmitted to the power tool. The transmitted data can be evaluated in the power tool in such a way that an optimal device characteristic is set for the power tool. This advantageously allows optimized operation of the power tool in that better adaptation of the operating parameters speed and torque to the task to be performed and/or to the tool that is used is made possible.

It is preferred in the context of the invention that the qualified operating range predetermines a “permitted range” in the speed-torque plot, with the user being able to select the characteristic points in this permitted range in order to determine or configure a user-optimized or application-optimized characteristic. What this preferably means is that operating range of the power tool in which the characteristic points can lie and in which there is advantageously no risk of a device defect or of some other operating risk when handling the power tool.

It is preferred in the context of the invention that the method is characterized by the following method steps:
a) determining characteristic points by the user of the power tool, wherein the characteristic points lie in a qualified operating range of the power tool,
b) operating the power tool according to the selected device characteristic.

It is preferred in the context of the invention that the characteristic points are determined by inputting the characteristic points into the power tool itself and/or on an input device. The corresponding inputs for the characteristic points can preferably be performed analogously to the inputs of the device characteristics. The selected device characteristic preferably corresponds to the user-optimized or application-optimized device characteristic, with the terms preferably being used synonymously.

It is particularly preferred in the context of the invention that, to determine the characteristic points by the user, the torque values and speed values are input by the user. Here, in each case a torque value and a speed value define a characteristic point. This preferably means in the context of the invention that a characteristic point is formed by a value pair, with the value pair comprising a torque value and a speed value. The input of the characteristic points or of the torque and speed values can occur on the power tool itself. For this purpose, the power tool can have a user interface which, for example, takes the form of an input screen or touchscreen. Alternatively or additionally, the input can be performed on a separate input device. This may be, for example, a mobile communication device such as a smartphone or a tablet PC.

It is preferred in the context of the invention that the device characteristic is assigned to an application field of the power tool. This preferably means in the context of the invention that, for different application areas of a power tool, different device characteristics can be stored in the power tool. These can be stored, for example, in a memory device and/or in lookup tables in the power tool.

A particular application for a power tool is the machining of plastic-coated surfaces, such as, for example, epoxy resin surfaces. For example, grinding devices having a rotating grinding disk as tool can be used to grind plastic-coated surfaces. Since, for example, epoxy resin has properties that are considerably different from concrete, it has proved advantageous in the context of the present invention if a different device characteristic is used or set for the machining of plastic-coated surfaces, such as epoxy resin, than for the machining of concrete surfaces. As a result, the performance of the power tool, particularly in the application for the machining of plastic-coated surfaces, can once again be significantly improved.

It is preferred in the context of the invention that the device characteristic can be characterized by a spread value S. The spread S preferably indicates the ratio of transition speed to idle speed, that is to say S=n_D/n_max. A typical device characteristic according to the invention preferably has two substantially horizontal ranges which, in the context of the invention, are designated as first and third subrange of the device characteristic. The first subrange of the device characteristic can preferably be assigned the idle speed n_max, whereas the third subrange can be assigned the transition speed n_D. The inventors have recognized that, for the machining of epoxy resin surfaces, a spread S in a range from 0.2 to 0.6 leads to particularly good results. The machining of epoxy resin surfaces can be further improved if the spread value S lies in a range from 0.3 to 0.5, particularly preferably in a range from 0.33 to 0.4, and most preferably at approximately 0.36.

In the context of the invention, a spread S of 0.36 preferably means that the transition speed n_D corresponds to a proportion of 36% of the idle speed n_max. With such a spread S, the invention departs considerably from the prior art in which spread values S of 0.7 to 0.8 are usually known. It is particularly preferred in the context of the invention that a plot of the power P of the power tool in the application of machining plastic-coated surfaces, such as epoxy resin, would give a hyperbola in the speed-torque plot. The power P of the power tool is preferably obtained as a product of torque and angular speed.

As a result, the user of the power tool has, under certain circumstances, less power available than when using conventional operating parameter combinations. However, tests have shown that the user of the power tool also receives clearer feedback on the falling speed. As a result, in particular the operating point before the tilt point can be found more easily. Moreover, working with the power tool in the application of machining plastic-coated surfaces, such as epoxy resin, can be made considerably easier for the user.

It is preferred in the context of the invention that the operating range, in particular the qualified operating range, of the power tool is determined by the speed n, the torque M and the control mode. Here, the term “control mode” preferably indicates whether a torque-based control or a speed-based control is present. The user of the power tool can set the operating behavior by predetermining the profile of a device characteristic or by setting or selecting a characteristic in the qualified operating range of the power tool. The qualified operating range of the power tool preferably corresponds to the admissible characteristic map which is illustrated, for example, in FIG. 3. The characteristics are preferably optimized within the qualified operating range of the power tool or within the admissible characteristic map. As a preferred exemplary embodiment of the invention there is a device characteristic for machining epoxy resin surfaces in which a spread, which is small by comparison with conventional spread values, is present. This preferably means in the context of the invention that the idle speed n_max and the transition speed n_D are situated further apart than in the case of conventional characteristics as are known from the prior art. By virtue of the preferably substantially free programming or determination of the characteristic points within the absolute minimum and maximum limits of the speed n and of the torque M, every point in the characteristic map or in the qualified operating range of the power tool can advantageously be reached.

In a second aspect, the invention relates to a power tool for carrying out the operating method. The terms, definitions and technical advantages introduced for the operating method preferably apply in an analogous manner to the power tool. The power tool is characterized in that a device characteristic for operating the power tool can be selected by a user, wherein a qualified operating range for the power tool is predetermined by the device characteristic. In particular, the device characteristic can be determined by characteristic points. It is preferred in the context of the invention that the characteristic points are selected or determined by a user of the power tool, wherein a qualified operating range for the power tool is predetermined by the characteristic points.

Further advantages will become apparent from the following description of the figures. The figures, the description and the claims contain numerous features in combination. A person skilled in the art will expediently also consider the features individually and combine them to form useful further combinations.

### BRIEF DESCRIPTION OF THE DRAWINGS

Identical and similar components are denoted by the same reference signs in the figures, in which:

FIG. 1 shows a view of an exemplary device characteristic with its characteristic points and subranges,

FIG. 2 shows a view of various exemplary device characteristics,

FIG. 3 shows a view of the qualified operating range of the power tool.

### DETAILED DESCRIPTION

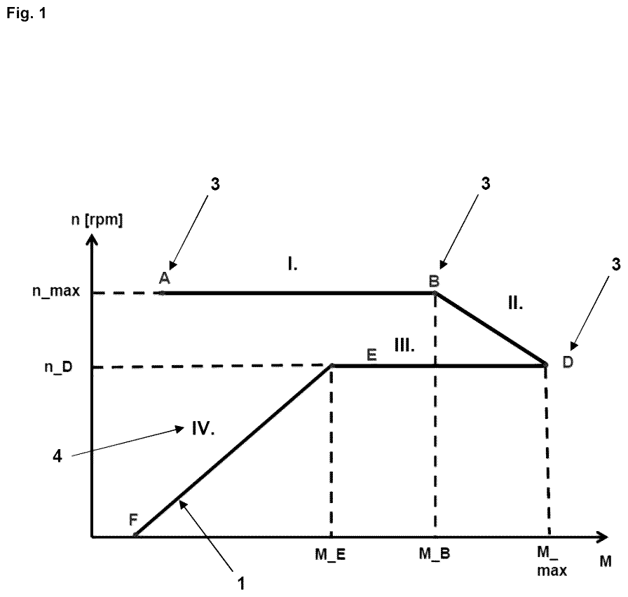

FIG. 1 shows an exemplary device characteristic 1 of a power tool, shown solely schematically as 100 with an input device 101 with its characteristic points 3 and subranges 4. The subranges are designated by Roman numerals I., II., III. and IV. in FIG. 1. The characteristic points 3 bear the references A, B, D, E and F. The characteristic points 3 represent the inflection points in the device characteristic 1, with the characteristic points 3 subdividing the device characteristic 1 into the individual subranges 4. In subrange I., the power tool preferably runs in idle before the actual work is begun with the power tool. In subrange I., the highest speed n_max is preferably reached, which, in the context of the invention, is preferably also referred to as idle speed. In subranges I and II, the power tool is put to work, to be precise with increasing contact pressure or with decreasing contact pressure. The second and the third subrange are separated from one another by the characteristic point D, with the loading maximum of the power tool being present at the characteristic point D. It is at point D that the highest torque M_max is reached, with the speed n at point D and in subrange III assuming the transition speed n_D. If the user exceeds point D, the output torque falls in order to signal an excessive contact pressure to the user.

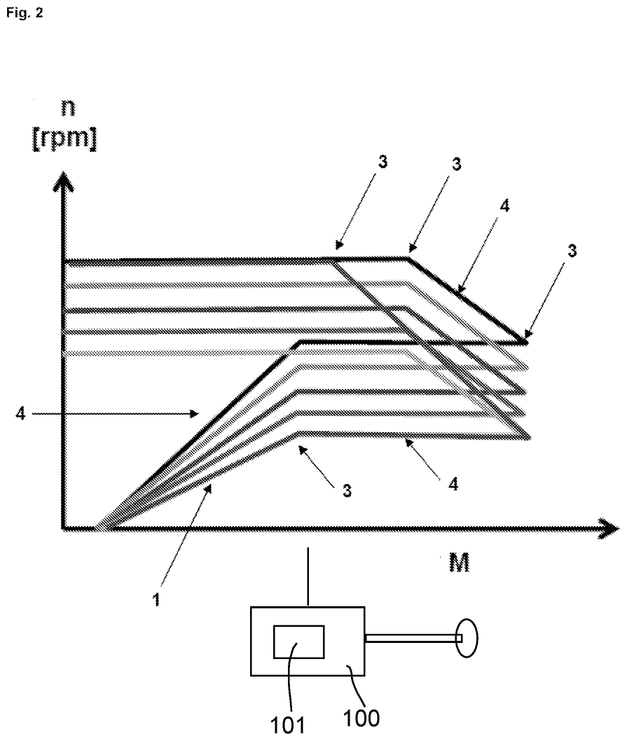

FIG. 2 shows by way of example various device characteristics 1 with their characteristic points 3 and subranges 4. The device characteristic 1, which assumes the lowest value for the speed n in particular in subrange III. and IV., is the device characteristic 1 which has been optimized for the application “machining of plastic-coated surfaces (epoxy resin)”. It has a spread S of approximately 0.36, with the result that the idle speed of the first subrange and the transition speed of the third subrange differ considerably more than in the case of conventional device characteristics 1.

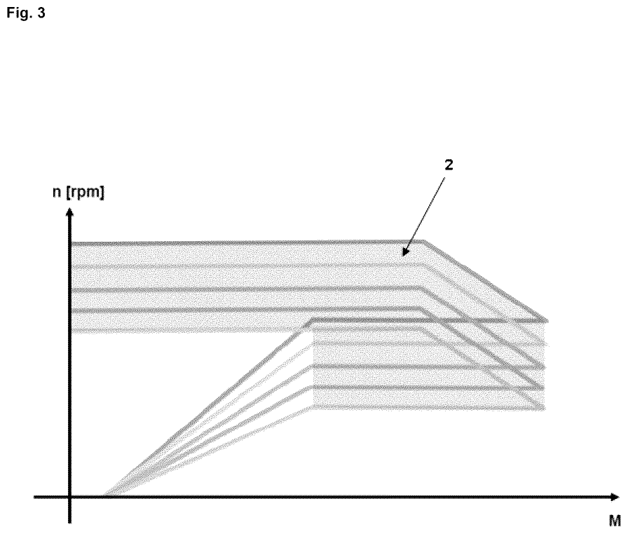

FIG. 3 shows one possible embodiment of the qualified operating range 2. FIG. 3—just like FIGS. 1 and 2—illustrates a speed-torque plot, with the speed n being plotted on the y-axis and the torque M being plotted on the x-axis. The qualified operating range 2 of the power tool is preferably characterized in that the user can select device characteristics 1 within its limits or can configure them himself by determining characteristic points 3.

### LIST OF REFERENCE SIGNS

1 Device characteristic
2 Qualified operating range of the power tool
3 Characteristic point
4 Subrange of the device characteristic

What is claimed is:

1-24. (canceled)

25: A method for operating a power tool, the method comprising:
selecting an application-optimized device characteristic by a user of the power tool, the application-optimized device characteristic lying in a qualified operating range of the power tool, the device characteristic having a spread value S lying in a range from 0.2 to 0.6.

26: The method as recited in claim 25 further comprising:
a) configuring the application-optimized device characteristic or a power tool and
b) operating the power tool with the application-optimized device characteristic,

27: The method as recited in claim 25 wherein the device characteristic is selected on the power tool itself or using an input device.

28: The method as recited in claim 25 wherein the device characteristic is determined by characteristic points.

29: The method as recited in claim 25 wherein the device characteristic comprises i characteristic points and (i−1) subportions.

30: The method as recited in claim 28 wherein each of the characteristic points is formed by a torque value M and a speed value n.

31: The method as recited in claim 28 wherein the characteristic points are determined by inputting the characteristic points into the power tool itself or on an input device.

32: The method as recited in claim 25 wherein the device characteristic is assigned to an application field of the power tool.

33: The method as recited in claim 25 wherein the spread value S lies in a range from 0.3 to 0.5.

34: The method as recited in claim 33 wherein the spread value S lies in a range from 0.33 to 0.4.

35: The method as recited in claim 34 wherein the spread value S lies at 0.36.

36: A power tool for carrying out the method as recited in claim 25 wherein the qualified operating range for the power tool is predetermined by the device characteristic.

37: The power tool as recited in claim 36 wherein the device characteristic is determinable by characteristic points.
